(19) United States
(12) Patent Application Publication
(10) Pub. No.: US 2007/0256322 A1
(43) Pub. Date: Nov. 8, 2007

(54) Dryer having heater-installed suction duct

(75) Inventors: Chang Hoo Kim, Gyeyang-gu (KR); Kyoung Hak Kim, Seo-gu (KR)

Correspondence Address: NATH & ASSOCIATES, PLLC, Sixth Floor, 1030 15th Street, N.W., Washington, DC, 20005, US

(73) Assignee: DAEWOO ELECTRONICS CORPORATION, Seoul (KR)

(21) Appl. No.: 11/790,344

(22) Filed: Apr. 25, 2007

(30) Foreign Application Priority Data
Apr. 27, 2006 (KR) 10-2006-38390
Dec. 20, 2006 (KR) 10-2006-131310

(51) Int. Cl. F26B 11/02

(52) U.S. Cl. 34/603; 34/604; 34/607

(57) ABSTRACT

Disclosed herein is a dryer having a heater-installed suction duct. The dryer can suppress heat loss while heated air is supplied to the drum, minimizing energy loss in the dryer, and can permit overhauling or replacement of the heater. The dryer comprises a cabinet having an exhaust port and an opening to which a door is provided, a drum rotatably located within the cabinet to accommodate clothes, a holding panel installed to an inner wall of the cabinet and having a through-hole part formed in the holding panel with the drum rotatably connected to the holding panel, a suction duct extending from the through-hole part, and a heater installed in the suction duct to heat air flowing into the drum. The dryer further comprises a cover detachably mounted to a hole formed in a rear side of the cabinet corresponding to the suction duct.

### BACKGROUND OF THE INVENTION

1. Field of the Invention

The present invention relates to a dryer, and, more particularly, to a dryer having a heater-installed suction duct that can suppress heat loss while air heated by a heater is supplied into a drum, thereby minimizing energy loss in the dryer.

2. Description of the Related Art

FIG. 1 is a diagram illustrating a flow path of a conventional dryer and FIG. 2 is a partially cut-away perspective view of the conventional dryer.

Referring to FIGS. 1 and 2, the conventional dryer comprises a cabinet 2 adapted to define an outer appearance and having a clothes inlet/outlet opening formed in the front side of the cabinet 2, a drum 12 rotatably installed within the cabinet 2 to accommodate clothes and opened in front and rear directions to allow air to pass therethrough, a heater 18 installed within the cabinet 2 to heat intake air, a suction duct 20 to guide heated air having passed through the heater 18 to the rear side of the drum 12, an exhaust mechanism 22 to exhaust air contaminated by drying the clothes to the outside of the cabinet 2, a fan (not shown) installed to the exhaust mechanism 22, a motor (not shown) and a belt 40 to drive the drum 12 and fan to rotate.

One or more lifters 11 are disposed on an inner peripheral surface of the drum 12 to raise and drop the clothes.

The exhaust mechanism 22 includes a lint duct 25 disposed to allow air discharged from the drum 12 to flow thereinto and having a filter 24 to filter foreign material contained in the air, a fan housing 26 communicated with the lint duct 25 while surrounding the fan 30, and an exhaust duct 27 having one end communicated with the fan housing 26 and the other end extending to the outside of the cabinet 2.

Operation of the conventional dryer constructed as above will be described hereinafter.

First, when a user operates the dryer after inputting clothes into the drum 12 and closing the door, the motor is driven to rotate the drum 12 and the fan along with operation of the heater 18.

Here, as the drum 12 is rotated, the clothes are raised and dropped by the lifters 11 within the drum 12. Then, air is sucked from the outside into the heater 18 by a blowing force generated by rotation of the fan, changed to have high temperature and low humidity by the heater 18, and supplied into the drum 12 through the suction duct 20.

The air having the high temperature and low humidity supplied into the drum 12 is brought into direct contact with the dropping clothes to dry the clothes, changed to have low temperature and high humidity by such drying operation while flowing toward the front side of the drum 12, and then discharged from the drum 12 to the outside of the dryer through the exhaust duct 27.

The conventional dryer constructed as above has a problem in that, since a separate duct extending from the suction duct so as to install the heater therein is located inside the cabinet, a distance between the heater and the drum cannot be reduced to a predetermined distance or less, so that air heated to have a predetermined temperature or more by the heater experiences heat loss while flowing into the drum.

Furthermore, the conventional dryer has a problem in that, since both the motor and heater likely to be overheated are installed within the cabinet without being separated, the interior of the cabinet is likely to be unduly overheated, causing malfunction or damage of the dryer resulting from overheating of the motor. Therefore, there is a need of a dryer that overcomes the above problems.

### SUMMARY OF THE INVENTION

The present invention has been made to solve the above problems, and an aspect of the present invention is to provide a dryer having a heater-installed suction duct that can suppress heat loss during flow of air into a drum after being heated by a heater. Another object of the present invention is to provide the dryer having the heater-installed suction duct that can prevent unduly heated air from being blown into the drum while suppressing the heat loss during flow of hot air supplied through the heater. Yet another object of the present invention is to provide the dryer having the heater-installed suction duct that can permit easy overhauling or replacement of the heater.

In accordance with one aspect of the present invention, a dryer having a heater-installed suction duct comprises: a cabinet having an exhaust port and an opening to which a door is provided; a drum rotatably installed inside the opening within the cabinet to accommodate laundry; a holding panel installed to an inner wall of the cabinet and having a through-hole part formed in the holding panel, the drum being rotatably connected to the holding panel; a suction duct extending from the through-hole part and having a suction port; and a heater installed in the suction duct to heat air flowing into the drum.

Preferably, the suction duct extends from the through-hole part to the suction port and protrudes from a rear side of the cabinet.

Preferably, the heater is installed inside the suction duct.

In accordance with another aspect of the present invention, a dryer having a heater-installed suction duct comprises: a cabinet having an exhaust port and an opening to which a door is provided; a drum rotatably installed inside the opening within the cabinet to accommodate laundry; a holding panel installed to an inner wall of the cabinet and having a through-hole part formed in the holding panel, the drum being rotatably connected to the holding panel; a suction duct extending from the through-hole part; a heater installed in the suction duct to heat air flowing into the drum; and a cover detachably mounted to a hole formed in a rear side of the cabinet corresponding to the suction duct.

Preferably, the hole is elongated in an up and down direction such that the suction duct can be separated to an outside of the cabinet through the hole.

Preferably, the hole has a coupling hole formed along a periphery of the hole. In addition, the cover has a protrusion formed along a periphery of the cover to be inserted into the coupling hole.

Preferably, the suction duct is formed with a suction port at a lower end of the suction duct corresponding to the rear side of the cabinet. In addition, the cover has an induction hole formed at a lower end of the cover corresponding to the suction port.

### BRIEF DESCRIPTION OF THE DRAWINGS

These and other objects and features of the present invention will be more clearly understood from the following detailed description taken in conjunction with the accompanying drawings, in which:

FIG. 1 is a diagram illustrating a flow path of a conventional dryer;

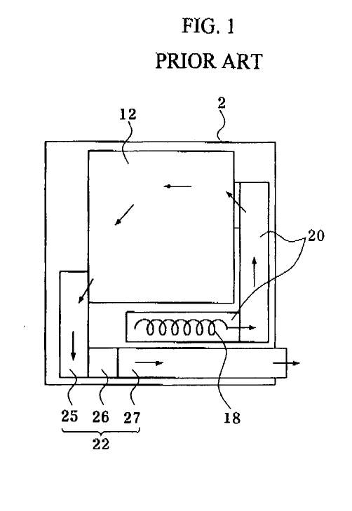

FIG. 2 is a partially cut-away perspective view of the conventional dryer;

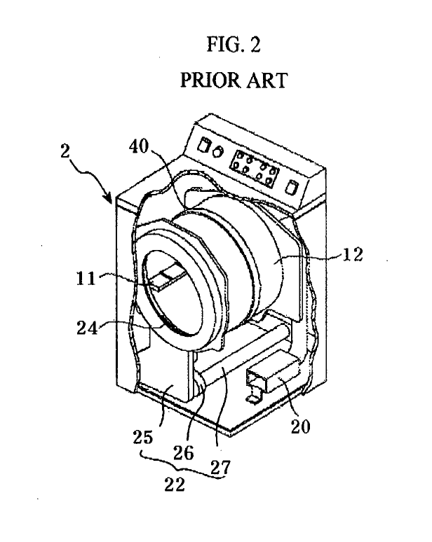

FIG. 3 is a rear perspective view of a dryer according to a first embodiment of the present invention;

FIG. 4 is a front perspective view of the dryer according to the first embodiment of the present invention;

FIG. 5 is a rear perspective view illustrating an exhaust port of the dryer according to the first embodiment of the present invention;

FIG. 6 is a front perspective view illustrating a vapor jet device of the dryer according to the first embodiment of the present invention;

FIG. 7 is a front perspective view of a suction duct of the dryer according to the first embodiment of the present invention;

FIG. 8 is a cross-sectional view of the suction duct taken along line A-A of FIG. 7;

FIG. 9 is a perspective view of a vapor jet device according to one embodiment of the present invention;

FIG. 10 is a cross-sectional view of the vapor jet device according to the one embodiment of the present invention;

FIG. 11 is a block diagram illustrating the vapor jet device according to the one embodiment of the present invention;

FIG. 12 is a sectional side elevation illustrating a suction flow path of the dryer according to the first embodiment of the present invention;

FIG. 13 is a plan view illustrating an exhaust flow path of the dryer according to the first embodiment of the present invention;

FIG. 14 is a rear exploded perspective view of a dryer according to a second embodiment of the present invention;

FIG. 15 is a front exploded perspective view of the dryer according to the second embodiment of the present invention;

FIG. 16 is a rear perspective view illustrating an exhaust port of the dryer according to the second embodiment of the present invention;

FIG. 17 is a front perspective view illustrating a suction duct of the dryer according to the second embodiment of the present invention;

FIG. 18 is a sectional side elevation illustrating a suction flow path of the dryer according to the second embodiment of the present invention; and

FIG. 19 is a plan view illustrating an exhaust flow path of the dryer according to the second embodiment of the present invention.

### DETAILED DESCRIPTION OF THE EMBODIMENTS

Exemplary embodiments of the present invention will be described in detail with reference to the accompanying drawings. For convenience of description, a dryer having a heater-installed suction duct will be described by way of example. It should be noted that the drawings are not to precise scale and may be exaggerated in thickness of lines or size of components for the purpose of convenience and clarity only.

Furthermore, terms used herein are defined in consideration of functions in the present invention and can be changed according to the custom or intention of users or operators.

Thus, definition of such terms should be determined according to overall disclosures set forth herein.

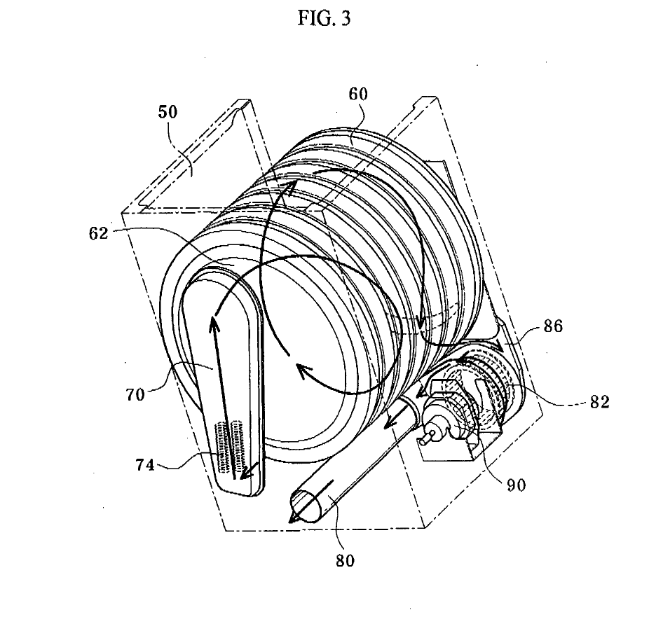

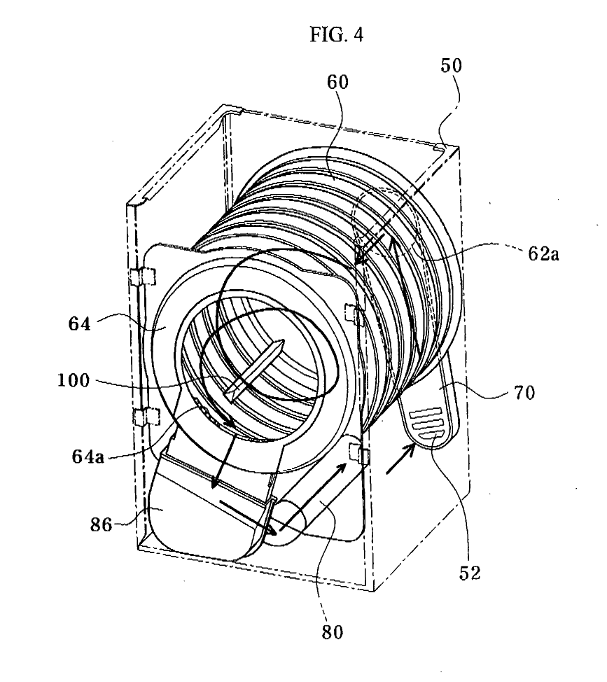

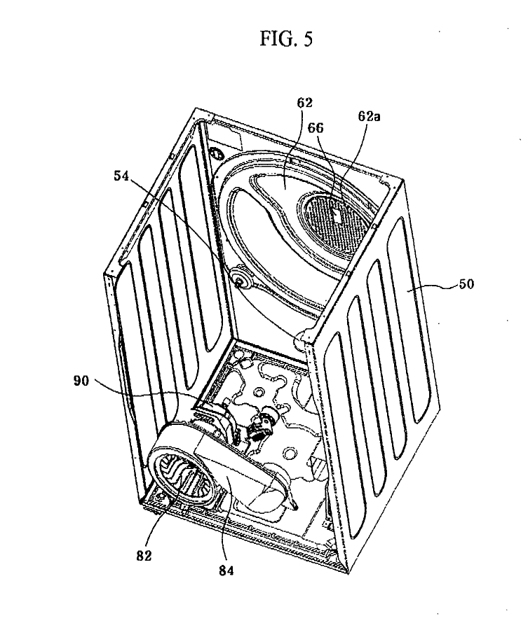

FIG. 3 is a rear perspective view of a dryer according to a first embodiment of the invention, FIG. 4 is a front perspective view of the dryer according to the first embodiment, and FIG. 5 is a rear perspective view illustrating an exhaust port of the dryer according to the first embodiment.

Referring to FIGS. 3 to 5, the dryer according to the first embodiment comprises: a cabinet 50 having an exhaust port 54 and an opening formed at one side thereof; a drum 60 rotatably installed inside the opening within the cabinet 50 to accommodate clothes; a lifter 100 formed on an inner wall of the drum 60 to rotate the clothes; a suction duct 70 having a suction port 52 to guide air inside the cabinet 50 into the drum 60; a heater 74 installed in the suction duct 70; an exhaust fan 82 disposed between the drum 60 and the exhaust port 54; an exhaust duct 80 disposed between the exhaust fan 82 and the exhaust port 54; and a driving motor 90 connected to a rotational shaft of the exhaust fan 82.

When power is applied to the motor 90 by handling of a user, the exhaust fan 82 is rotated to circulate air. Air is heated by the heater 74 while passing through the heater 74 and supplied into the drum 60 where the air is brought into contact with clothes to dry or sterilize the clothes. When air is exhausted by operation of the exhaust fan 82, it flows along the exhaust duct 80 and is then discharged to the outside of the dryer through the exhaust port 54 of the cabinet 50. Here, the exhaust port 54 is formed at a lower portion of the rear side of the cabinet 50, as shown in FIG. 5. It is desirable that the exhaust port 54 be formed at the center of the lower portion thereof.

The drum 60 has a cylindrical shape opened at front and rear sides thereof such that the front side of the drum corresponds to the opening of the cabinet 50 and the rear side of the drum is rotatably installed to a holding panel 62 having a through-hole part 62a formed therein. Here, the holding panel 62 is installed to an inner wall of the rear side of the cabinet 50 such that the drum 60 can be rotatably held by the holding panel 62 and the suction duct 70 is connected to the through-hole part 62a of the holding panel 62.

In addition, the drum 60 is provided with a gasket 64, which is interposed between the front end of the drum 60 and the opening of the cabinet 50, and has a discharge port 64a formed at a lower side of the gasket 64. An extension duct 86 is connected to the discharge port 64a and extends to the exhaust fan 82, and, a housing 84 rotatably receiving the exhaust fan 82 is disposed between the extension duct 86 and the exhaust duct 80.

The suction duct 70 extends from the through-hole part 62a to the suction port 52 and protrudes from the rear side of the cabinet 50. That is, the suction duct 70 defines a passage extending from the suction port 52 to an upper portion of the rear side of the cabinet 50 corresponding to the through-hole part 62a. Thus, air induced from the interior of the cabinet 50 is heated to a predetermined temperature or more by the heater 74 while passing through the heater 74, flows to the upper portion of the cabinet 50 along the suction duct 70, and is then induced into the drum 60 through the through-hole part 62a. At this time, the drum 60 connected to the driving motor 90 via the belt 96 is rotated to increase a contact area between heated air and clothes, so that the dryer can perform operation of drying or sterilizing the clothes. Here, the heater 74 is preferably disposed within the suction duct 70 located outside the cabinet 50. Accordingly, the dryer of the invention has a reduced distance between the heater 74 and the drum 60 as compared with the conventional dryer wherein the heater 74 is located inside the cabinet 50.

In addition, since it is possible to minimize heat loss occurring while air heated to have a predetermined temperature or more by the heater 74 flows along the suction duct 70, the dryer can be maximized in efficiency.

Furthermore, since the heater 74 is disposed at a location outside the cabinet 50, that is, in a discrete space from that of the driving motor 90, which is likely to be overheated, the interior of the cabinet 50 can be prevented from being unduly overheated, which makes it possible to prevent malfunction or damage of the dryer caused by overheating of the driving motor 90.

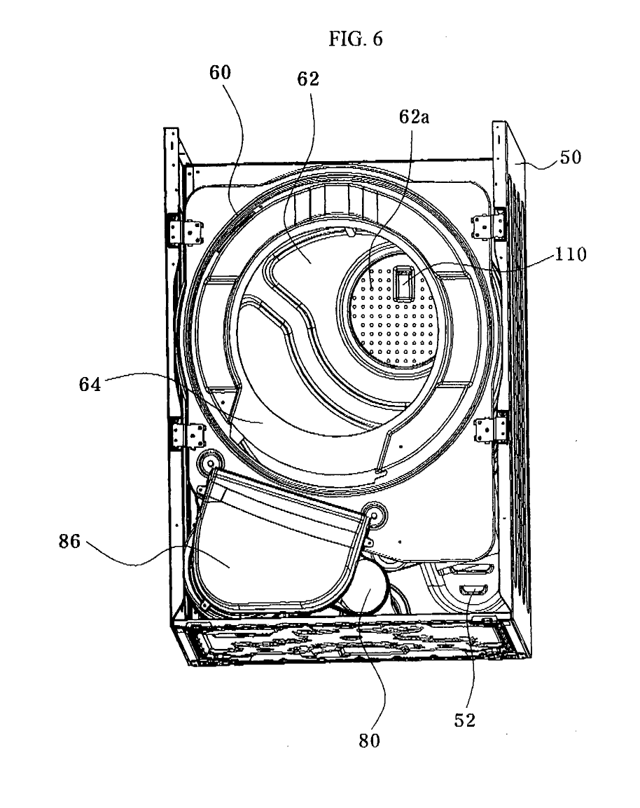

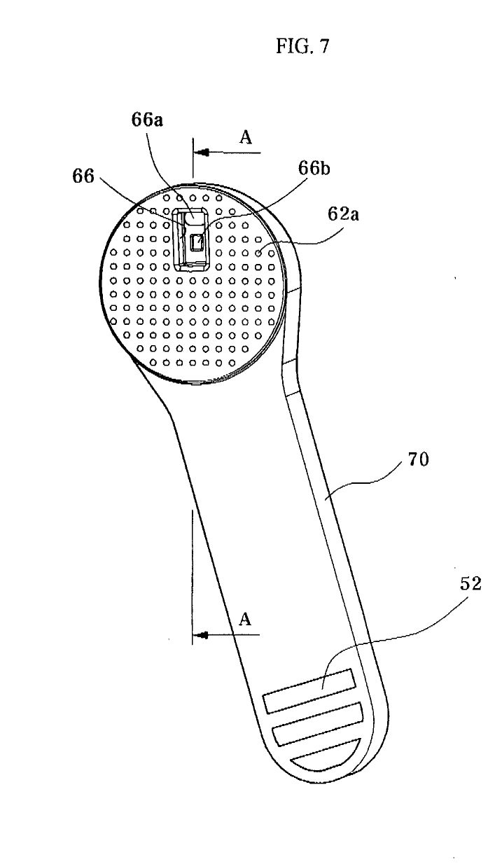

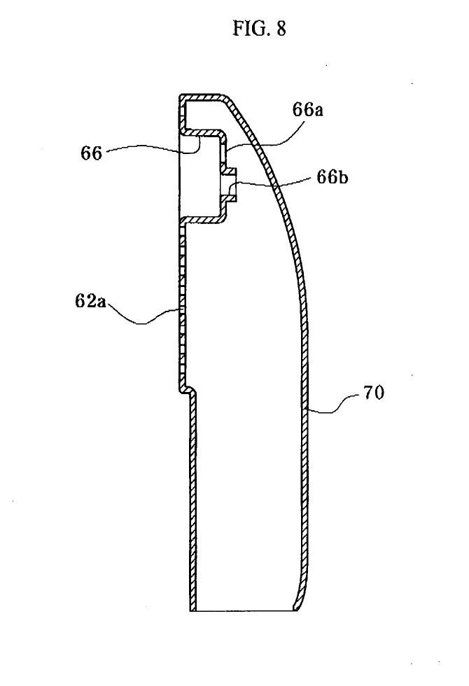

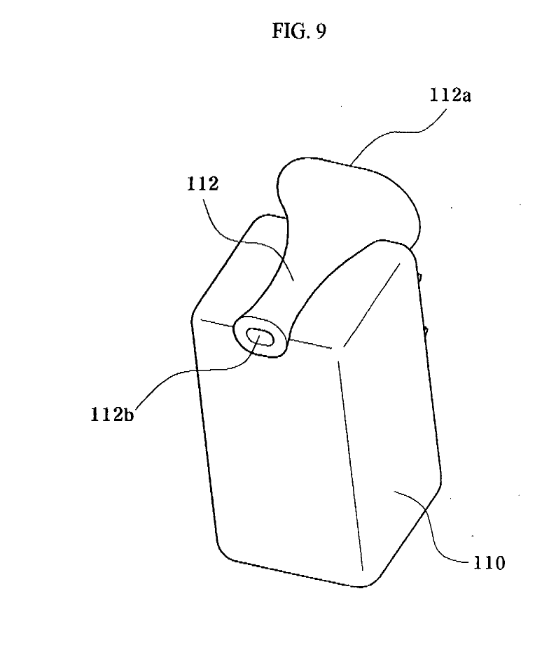

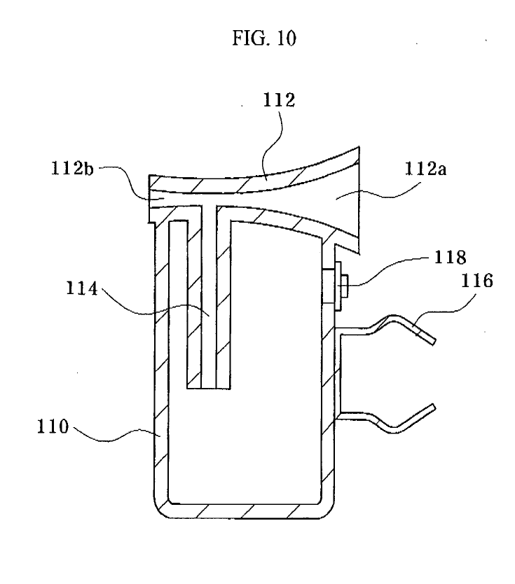

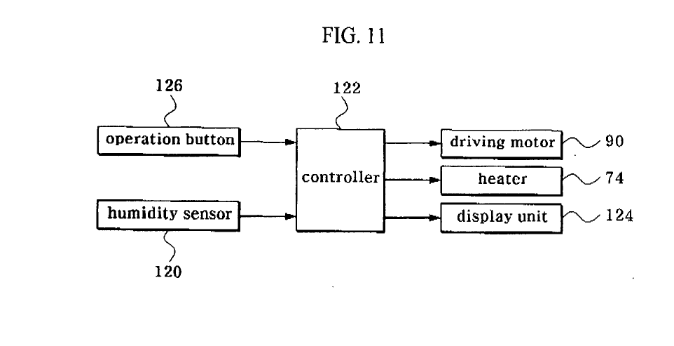

FIG. 6 is a front perspective view illustrating a vapor jet device of the dryer according to the first embodiment of the present invention, FIG. 7 is a front perspective view of the suction duct of the dryer according to the first embodiment, and FIG. 8 is a cross-sectional view of the suction duct taken along line A-A of FIG. 7. Furthermore, FIG. 9 is a perspective view of a vaporjet device according to one embodiment of the invention, FIG. 10 is a cross-sectional view of the vapor jet device according to the one embodiment, and FIG. 11 is a block diagram illustrating the vaporjet device according to the one embodiment.

Referring to FIGS. 6 to 11, the vapor jet device in this embodiment comprises a case 110 detachably mounted to the through-hole part 62a to contain water, a nozzle 112 located corresponding to the through-hole part 62a and having one side communicated with the case 110 such that water can be injected into the drum 60 through the nozzle 112 by vacuum generated within the case 110 when air supplied through the through-hole part 62a passes through the nozzle 112, an attachment mechanism 66b and 116 disposed between the case 110 and the holding panel 62 and used to detachably mount the case 110 to the holding panel 62, a humidity sensor 120 to detect the humidity of the drum 60 and send an electrical signal if it is determined that the humidity of the drum 60 is a preset value or more, a controller 122 to intercept a power source from the driving motor 90 and heater 74 in response to the signal sent from the humidity sensor 120, and a display unit 124 to output a completion signal so as to inform a user of power interception when the power source is intercepted from the driving motor 90 and heater 74. Here, the through-hole part 62a is formed with a mounting site 66 into which the case 110 is inserted and which has a supply hole 66a formed at one side of the mounting site 66 corresponding to the nozzle 112. Air flowing into the drum 60 along the suction duct 70 is changed to dry hot air of a predetermined temperature or more while passing through the heater 74, and flows into the drum 60 through the through-hole part 62a. Here, the hot air is brought into contact with the case 110 and heats water in the case 110 to a predetermined temperature or more, thereby generating vapor. Then, air induced into the supply hole 66a forces the vapor generated within the case 110 to be injected into the drum 60 while passing through the nozzle 112.

The case 110 is formed at one side with an entrance and a stopper 118, and is adapted to allow water to be supplied into the case 110 through the entrance and to be injected as vapor into the drum through the nozzle 112 integrally formed with the top of the case 110.

The nozzle 112 comprises an inlet 112a corresponding to the through-hole part 62a, an outlet 112b facing the interior of the drum 60 and having a greater diameter than that of the inlet 112a, and an injection tube 114 extending into the case 110. When the case 110 filled with water is closed by the stopper 118 and inserted into the mounting site 66, the case 110 is received inside the through-hole part 62a by means of the attachment mechanism. As drying operation is performed, air to be supplied into the drum 60 through the supply hole 66a passes through the nozzle 112. At this time, while passing through the nozzle 112, the air is accelerated due to a difference in diameter between the inlet 112a and the outlet 112b, and is injected into the drum 60. Since the air generates vacuum within the case 110 via the Venturi effect while passing through the nozzle 112, vapor generated within the case 110 is forced to flow into the nozzle 112 along the injection tube 114, so that the vapor is injected into the drum 60 along with accelerated air and brought into contact with clothes in the drum 60.

Referring to FIGS. 8 and 10, the attachment mechanism 66b and 116 comprises a pair of hooks 116 formed at one side of the case, and an insertion hole 66b formed at the mounting site corresponding to the hooks 116 such that the hooks 116 can be fitted into the insertion hole. With such configuration, when the case 110 is inserted into the mounting site 66, the hooks 116 are deformed inwardly and coupled to the insertion hole 66b, and, when coupling of the case 110 is completed, the hooks 116 return to their original shapes, preventing separation of the case 110.

Operation of the dryer with the aforementioned vapor jet device according to the first embodiment of the present invention will be described as follows.

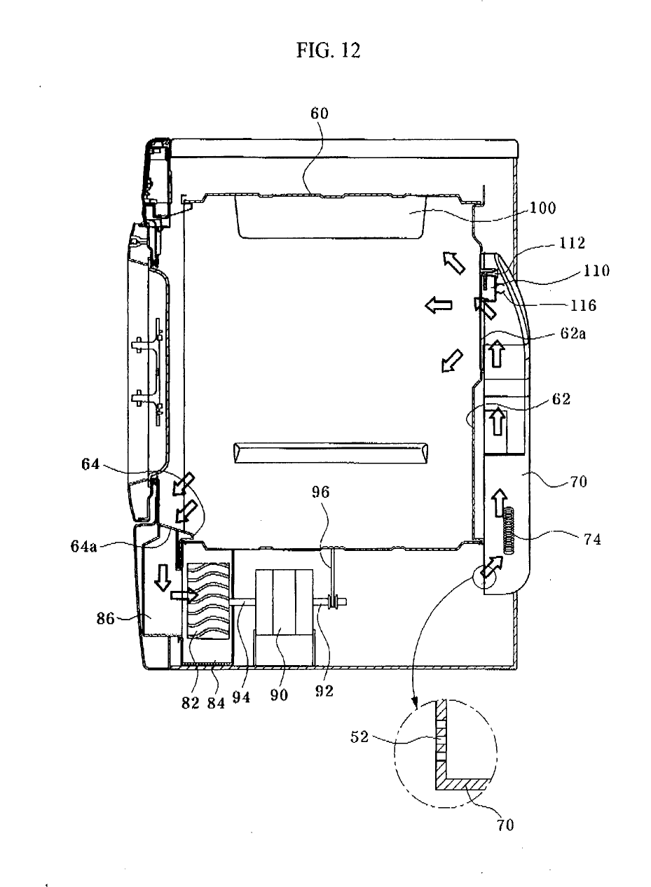

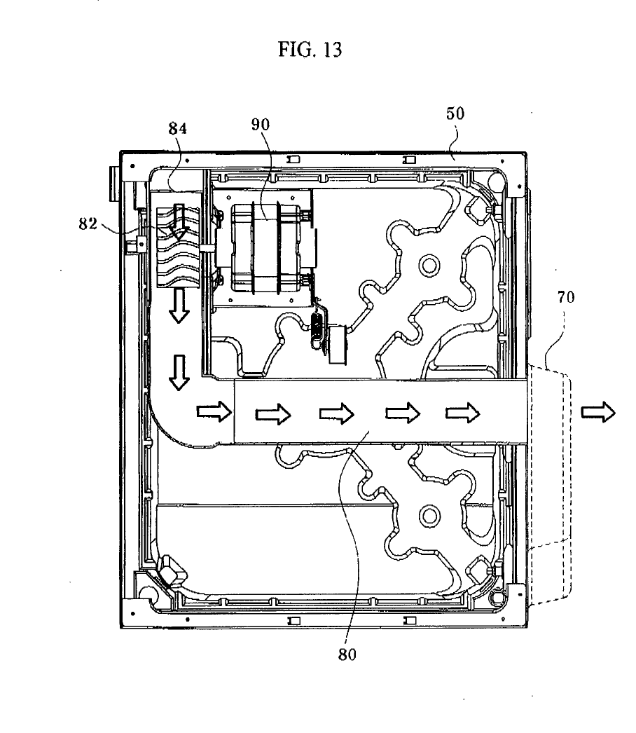

FIG. 12 is a sectional side elevation illustrating a suction flow path of the dryer according to the first embodiment of the present invention, and FIG. 13 is a plan view illustrating an exhaust flow path of the dryer according to the first embodiment.

Operation of this embodiment is described with reference to FIGS. 3 to 13. First, after separating the stopper 118 from the case 110 and filling the case 110 with water, the case 110 is provided to the holding panel 62 through an opened door of the cabinet 50. Then, when the case 110 is inserted into the mounting site 66, the hooks 116 are fitted into the insertion hole 66b so that the case 110 is mounted to the through-hole part.

Power is applied to the driving motor 90 and heater 74 via an operation button 126 to rotate the exhaust fan 82 and drum 60. By rotation of the exhaust fan 82, air induced into the suction duct 70 through the suction port 52 flows to an upper portion of the cabinet 50 along the suction duct 70 extending in the vertical direction on the rear side of the cabinet 50 and is then supplied into the drum 60, as shown in FIG. 12. While flowing to the upper portion of the cabinet, the air is heated by the heater 74 to become dry hot air having a predetermined temperature or more.

Air induced into the drum 60 through the through-hole part 62a is brought into contact with clothes while swirling around within the drum 60, thereby drying the clothes. While passing through the through-hole part 62a, the air is heated to evaporate water contained in the case 110 and generates vacuum within the case via the Venturi effect while passing through the nozzle 112 via the supply hole 66a, so that vapor in the case 110 is forced to flow along the injection tube 114 and to be injected into the drum 60 through the outlet 112b of the nozzle 112.

After drying the clothes, air is discharged from the drum 60 through the discharge port 64a formed in the gasket 64 between the opening of the drum 60 and the inner wall of the cabinet 50, flows into the housing 84 receiving the exhaust fan 82 through the extension duct 86 communicated with the discharge port 64a, and is then discharged to the outside of the cabinet 50 through the exhaust port 54 via the exhaust duct 80.

During such drying operation of the dryer, the humidity of the drum 60 is detected by the humidity sensor 120. When the humidity of the drum 60 increases to a preset value or more, the humidity sensor 120 detects the humidity increase and sends an electrical signal indicating the humidity increase. When the humidity of the drum 60 is a preset value or less, power is supplied to the driving motor 90 and heater 74 so as to allow hot air and vapor to be injected toward the clothes within the drum 60 so that the clothes are removed of crinkles, odor particles, bacteria, etc. As a result, even though the clothes have been stored for a long time within a closed space, it is possible to remove the crinkles, odor, bacteria, etc. from the clothes with the dryer of the invention.

As described above, during the drying operation, when the humidity sensor 120 detects the humidity increase to the preset value or more, the electrical signal is sent from the humidity sensor 120 to the controller 122, and, power is intercepted from the driving motor 90 and heater 74 in response to an electrical signal from the controller 122, thereby completing the drying operation. At this time, completion of the drying operation is output from the display unit 124 in response to the signal from the controller 122. Since the display unit 124 comprises a typical sound generator or lamp, the user can be informed of completion of drying or sterilizing operation by a signal sound from the sound generator or light from the lamp.

Of course, if the dryer is operated in a state wherein only clothes is received within the drum 60 and the case 110 is not mounted to the through-hole part 62a, the dryer of the invention will also perform a typical drying operation as in a conventional dryer.

As described above, according to the invention, since the distance between the heater and the drum is sufficiently reduced to minimize heat loss during flow of air heated by the heater to the drum, it is possible to realize a dryer that can maximize thermal efficiency.

Furthermore, according to the present invention, it is possible to realize a dryer including a vapor jet device that can make it possible to satisfactorily remove crinkles, odor, bacteria, etc. from clothes without washing the clothes by injecting hot air and vapor toward the clothes, even though the clothes have been stored for a long time within a closed space.

Next, a dryer having a heater-installed suction duct according to a second embodiment of the present invention is described in detail with reference to the accompanying drawings.

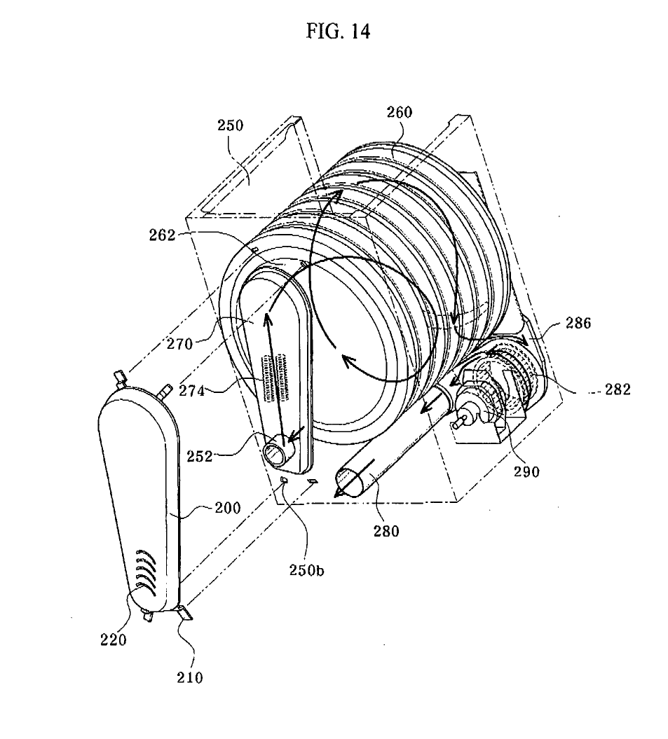

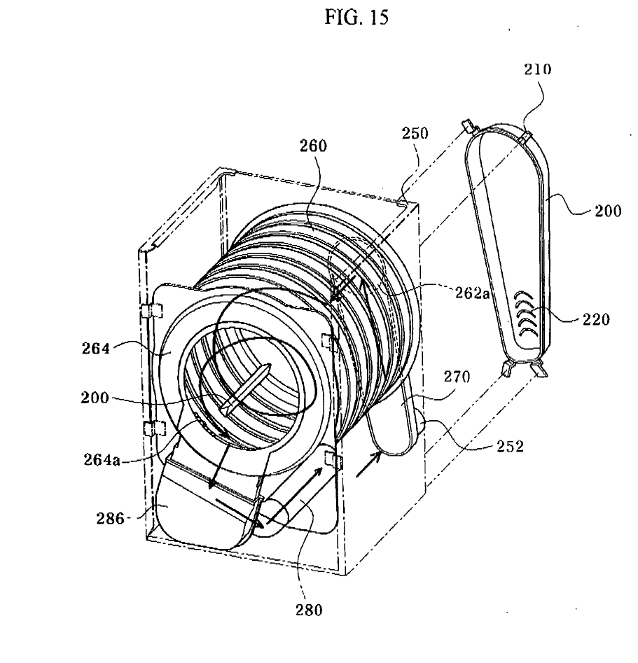

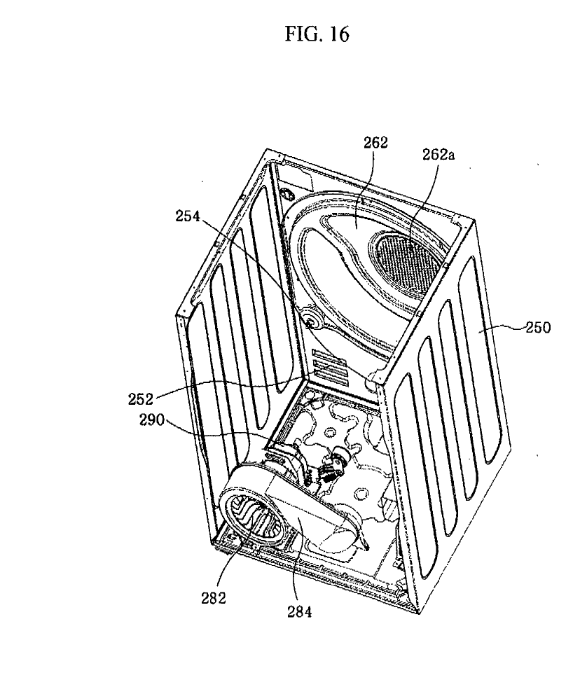

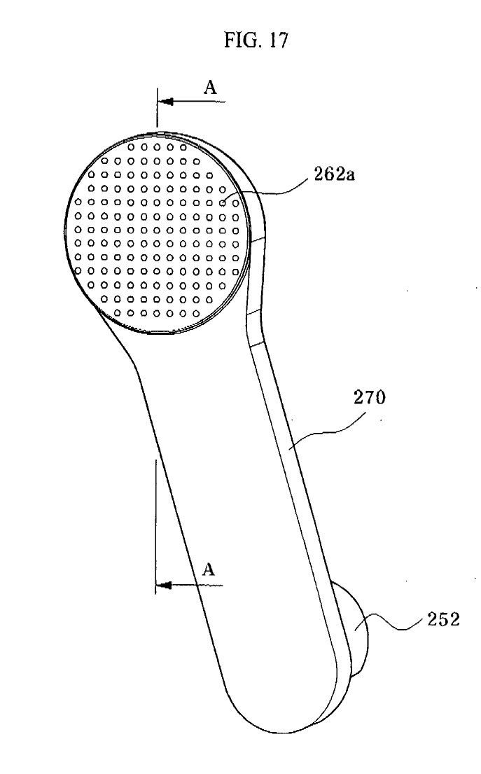

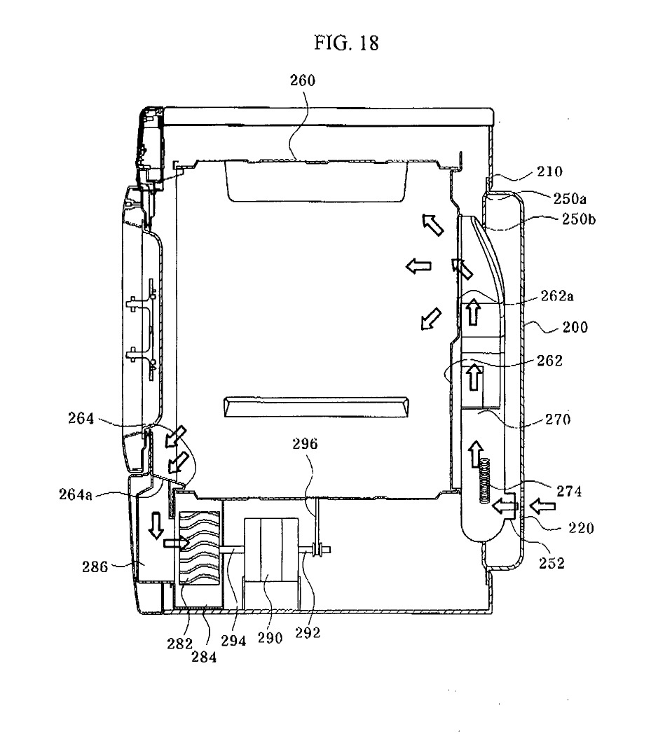

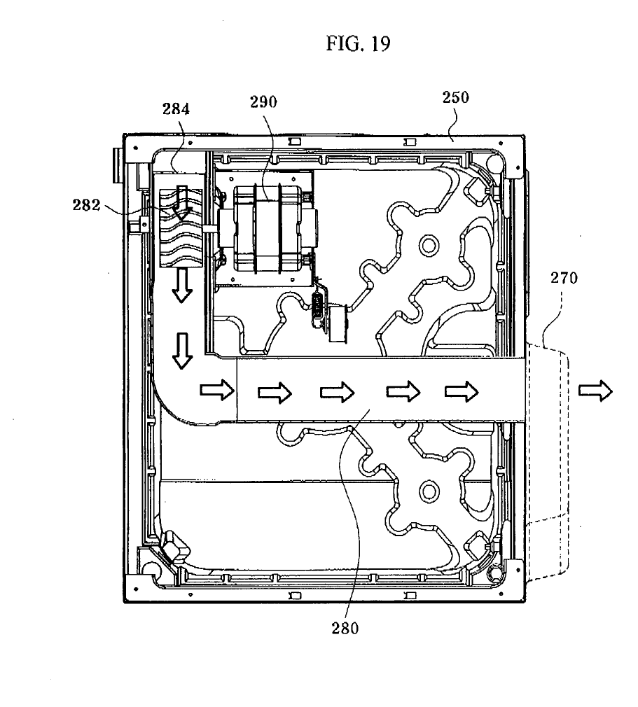

FIG. 14 is a rear exploded perspective view of a dryer according to the second embodiment, FIG. 15 is a front exploded perspective view of the dryer according to the second embodiment, FIG. 16 is a rear perspective view illustrating an exhaust port of the dryer according to the second embodiment, FIG. 17 is a front perspective view illustrating a suction duct of the dryer according to the second embodiment, FIG. 18 is a sectional side elevation illustrating a suction flow path of the dryer according to the second embodiment, and FIG. 19 is a plan view illustrating an exhaust flow path of the dryer according to the second embodiment.

Referring to FIGS. 14 to 19, the dryer according to the second embodiment comprises: a cabinet 250 having an exhaust port 254 and an opening formed at one side thereof; a drum 260 rotatably installed inside the opening within the cabinet 250 to accommodate clothes; a suction duct 270 having a suction port 252 to guide air inside the cabinet 250 into the drum 260; a heater 274 installed within the suction duct 270; an exhaust fan 282 disposed between the drum 260 and the exhaust port 254; an exhaust duct 280 disposed between the exhaust fan 282 and the exhaust port 254; a driving motor 290 connected to a rotational shaft of the exhaust fan 282; and a cover 200 detachably mounted to a rear side of the cabinet 250 corresponding to the suction duct 270.

When power is applied to the motor 290 by handling of a user, the exhaust fan 282 is rotated to circulate air. After being induced through the suction port 252, air is heated by the heater 274 while passing through the heater 274 and supplied into the drum 260 where the air is brought into contact with clothes to dry or sterilize the clothes. When air is exhausted operation of the exhaust fan 282, it flows along the exhaust duct 280 and is then discharged to the outside of the dryer through the exhaust port 254 of the cabinet 250. Here, the exhaust port 254 is formed at a lower portion of the rear side of the cabinet 250. It is desirable that the exhaust port 254 be formed at the center of the lower portion thereof.

The drum 260 has a cylindrical shape opened at front and rear sides thereof such that the front side of the drum corresponds to the opening of the cabinet 250 and the rear side of the drum is rotatably installed to a holding panel 262 having a through-hole part 262a formed therein. Here, the holding panel 262 is installed to an inner wall of the rear side of the cabinet 250 such that the drum 260 can be rotatably held by the holding panel 262 and the suction duct 270 is connected to the through-hole part 262a of the holding panel 262.

In addition, the drum 260 is provided with a gasket 264, which is interposed between the front end of the drum 260 and the opening of the cabinet 250, and has a discharge port 264a formed at a lower side of the gasket 264. An extension duct 286 is connected to the discharge port 264a and extends to the exhaust fan 282, and, a housing 284 for rotatably receiving the exhaust fan 282 is disposed between the extension duct 286 and the exhaust duct 280.

The suction duct 270 defines a passage extending from the suction port 252 to an upper portion of the rear side of the cabinet 250 corresponding to the through-hole part 262a. Thus, air induced from the interior of the cabinet 250 is heated to a predetermined temperature or more by the heater 274 while passing through the heater 274, flows to an upper portion of the cabinet 250 along the suction duct 270, and is then induced into the drum 260 through the through-hole part 262a. At this time, the drum 260 connected to the driving motor 290 via the belt 296 is rotated to increase a contact area between heated air and clothes, so that the dryer can perform operation of drying or sterilizing the clothes. Here, preferably, the suction duct 270 protrudes from the rear side of the cabinet 250. Furthermore, according to the second embodiment, the heater 274 is disposed within the suction duct 270 located outside the cabinet 250. Accordingly, the dryer of the invention has a reduced distance between the heater 274 and the drum 260 as compared with the conventional dryer wherein the heater 274 is located inside the cabinet 250.

In addition, since it is possible to minimize heat loss occurring while air heated to have a predetermined temperature or more by the heater 274 flows along the suction duct 270, the dryer can be maximized in efficiency.

Furthermore, since the heater 274 is disposed at a location outside the cabinet 250, that is, in a discrete space from that of the driving motor 290, which is likely to be overheated, the interior of the cabinet 250 can be prevented from being unduly overheated, which makes it possible to prevent malfunction or damage of the dryer caused by overheating of the driving motor 290.

A hole 250a is formed at a location in the rear side of the cabinet 250 corresponding to the suction duct 270 such that the cover 200 can be detachably attached to the hole 250a. The hole 250a is elongated in an up and down direction such that the suction duct 270 can be separated to the outside of the cabinet 250 through the hole 250a. Therefore, in the event where there is malfunction or damage of the heater 274, it is possible to perform easy overhauling or replacement of the heater 274 by detaching the cover 200 from the hole 250a of the cabinet 250 and separating the suction duct 270 having the heater 274 installed therein from the cabinet 250.

For attachment of the cover 200 to the hole 250a, a plurality of coupling holes 250b are formed along a periphery of the hole 250a, and, a plurality of protrusions 210 are formed along a periphery of the cover 200 to be inserted into the coupling holes 250b. With this configuration, after sliding the cover 200 upward to insert the protrusions 210 at an upper portion of the cover 200 into the coupling holes 250b, the cover 200 is lowered to render the protrusions 210 at a lower portion of the cover 200 coincident with the coupling holes 250b formed at a lower portion of the cabinet 250, followed by making the protrusions 210 at the lower portion of the cover 200 inserted into the coupling holes 250b, so that the cover 200 is coupled to the hole 250a.

Additionally, the suction duct 270 has the suction port 252 formed at a lower end of the suction duct side corresponding to the rear side of the cabinet 250 and the cover 200 has an induction hole 220 formed at a lower end of the cover 200 corresponding to the suction port 252, so that external air can be induced into air flowing into the drum 260 along the suction duct 270. Since external air has a lower temperature than that of air within the cabinet 250 where the driving motor 290 and the heater 274 are installed, it is possible to prevent the interior of the suction duct 270 and drum 260 from being unduly overheated.

Operation of the dryer with the aforementioned vapor jet device according to the second embodiment of the present invention will be described as follows.

First, when drying operation of the dryer is started by a user, power is applied to the driving motor 290 and heater 274 to rotate the exhaust fan 282 and drum 260. By rotation of the exhaust fan 282, air induced into the suction duct 270 through the induction hole 220 and the suction port 252 flows to an upper portion of the cabinet 250 along the suction duct 270 extending in the vertical direction on the rear side of the cabinet 250 and is then supplied into the drum 260. While flowing to the upper portion of the cabinet 250, air is heated by the heater 274 to become dry hot air having a predetermined temperature or more. At this time, since the dryer of the invention has a short traveling distance of air from the heater 274 to the drum 260 after the air is induced into the suction unit 270, heat loss during traveling of the air is reduced, making it possible to supply sufficient thermal energy even with the heater 274 which has smaller capacity than that of a conventional technique.

Furthermore, since external air of a lower temperature is also supplied into the suction duct 270 through the induction hole 220 and suction port 252, it is possible to prevent the interior of the suction duct 270 and drum 260 from being overheated.

Air induced into the drum 260 through the through-hole part 262a is brought into contact with clothes while swirling around within the drum 260, thereby drying the clothes.

The discharge port 264a is formed at the lower end of the gasket 264 interposed between the opening of the drum 260 and the inner wall of the cabinet 250. After drying the clothes, air is discharged from the drum 260 through the discharge port 264a, flows into the housing 284 of the exhaust fan 282 through the extension duct 286 communicated with the discharge port 264a, and is then discharged to the outside of the cabinet 250 through the exhaust port 254 via the exhaust duct 280.

As apparent from the above description, according to the present invention, the dryer with a heater-installed suction duct comprises a heater installed in a suction duct so as to reduce a distance between the heater and a drum, so that heat loss is suppressed during flow of air into the drum after being heated by the heater and the interior of the drum can be sufficiently heated by the heater having low capacity, thereby reducing cost for manufacture and operation of the dryer.

In addition, according to the invention, the heater and the motor, both of which are likely to be overheated, are located at different spaces in the dryer, so that the motor can be prevented from being unduly overheated, which makes it possible to prevent malfunction or damage of the dryer caused by overheating of the motor.

Furthermore, according to the invention, a cover is detachably mounted to the rear side of a cabinet corresponding to the suction duct and allows easy overhauling or replacement of the heater after detaching the cover from the cabinet if there is malfunction or damage of the heater, thereby reducing cost and time for overhauling or replacement of the heater.

Moreover, according to the invention, the cover has an induction hole and the suction unit has a suction port corresponding to the induction hole to allow external air to be supplied into the suction duct, thereby preventing the interior of the suction duct and drum from being unduly overheated by the heater.

Although the present invention has been described with reference to the embodiments shown in the drawings, it should be understood that these embodiments are provided for illustrative purpose and that various equivalent modifications and alterations will be apparent to those skilled in the art without departing from the scope and spirit of this invention.

In addition, although the present invention has been described with reference to the dryer having the heater-installed suction duct as specifically described herein, it should be noted that the dryer having the heater-installed suction duct has been illustrated by way of example, and that the heater-installed suction duct of the present invention may be applied to other components without being limited to the dryer in its application.

Therefore, the scope and sprit of the invention is limited only by the claims set forth herein as follows.

What is claimed is:

1. A dryer having a heater-installed suction duct, comprising:
a cabinet having an exhaust port and an opening to which a door is installed;
a drum rotatably installed inside the opening within the cabinet to accommodate laundry;
a holding panel installed to an inner wall of the cabinet and having a through-hole part formed in the holding panel, the drum being rotatably connected to the holding panel;
a suction duct extending from the through-hole part and having a suction port; and
a heater installed in the suction duct to heat air flowing into the drum.

2. The dryer according to claim 1, wherein the suction duct extends from the through-hole part to the suction port and protrudes from a rear side of the cabinet.

3. The dryer according to claim 1, wherein the heater is installed within the suction duct.

4. A dryer having a heater-installed suction duct, comprising:
a cabinet having an exhaust port and an opening to which a door is installed;
a drum rotatably installed inside the opening within the cabinet to accommodate laundry;
a holding panel installed to an inner wall of the cabinet and having a through-hole part formed in the holding panel, the drum being rotatably connected to the holding panel;
a suction duct extending from the through-hole part;
a heater installed in the suction duct to heat air flowing into the drum; and
a cover detachably mounted to a hole formed in a rear side of the cabinet corresponding to the suction duct.

5. The dryer according to claim 4, wherein the hole is elongated in an up and down direction such that the suction duct can be separated to an outside of the cabinet through the hole.

6. The dryer according to claim 4, wherein the hole has a coupling hole formed along a periphery of the hole.

7. The dryer according to claim 6, wherein the cover has a protrusion formed along a periphery of the cover to be inserted into the coupling hole.

8. The dryer according to claim 4, wherein the suction duct is formed with a suction port at a lower end of the suction duct corresponding to the rear side of the cabinet.

9. The dryer according to claim 8, wherein the cover has an induction hole formed at a lower end of the cover corresponding to the suction port.
